(19) United States
(12) Patent Application Publication
(10) Pub. No.: US 2007/0131883 A1
(43) Pub. Date: Jun. 14, 2007

(54) Hydraulic drive system

(76) Inventors: Ronald Goodrich, Logansport, IN (US); Robert E. Bettcher III, Wlnamac, IN (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 10/575,817

(22) PCT Filed: Oct. 13, 2004
(86) PCT No.: PCT/US04/33714

§ 371 Date: Apr. 14, 2006

Related U.S. Application Data
(60) Provisional application No. 60/510,905, filed on Oct. 14, 2003.

(51) Int. Cl. F16K 31/12

(52) U.S. Cl. 251/12

(57) ABSTRACT

A hydraulic drive system for reversibly operating a device such as a wheelchair ramp or other type of mobility access device is provided. The hydraulic drive system includes a bi-directional power unit that is in fluid communication with a cylinder for deploying and stowing the ramp. The system further includes valves disposed between the cylinder and pump, which may be spring biased shuttle-type valves. In one embodiment, the valves are normally biased so that the cylinder and ramp may move freely such that the ramp may be manually operated during a loss of electrical power to the power unit.

### CROSS-REFERENCE TO RELATED APPLICATION

This application claims the benefit of U.S. Provisional Patent Application No. 60/510,905, filed Oct. 14, 2003.

### FIELD OF THE INVENTION

The invention relates to hydraulic systems. More particularly, the present invention relates to a bi-directional hydraulic drive system for a mobility access device, such as a vehicle wheelchair ramp.

### BACKGROUND OF THE INVENTION

Wheelchair ramp systems for vehicles are well known, and have been employed to enable persons who are physically challenged or otherwise have limited mobility to board and leave a vehicle. Various wheelchair ramp systems have been proposed that include electrical, pneumatic, or hydraulic drive systems. Recently, hydraulic driven wheelchair ramp systems have become more prevalent due to their durability, reliability, and ability to be integrated with existing vehicle hydraulics. However, existing hydraulic systems are disadvantaged in that they are generally unduly complicated, requiring solenoid valves or the like to implement reversible operation of a ramp. Therefore, it would be advantageous to provide a simplified hydraulic system for reversible actuation of a wheelchair ramp, lift or other mobility access device for a vehicle.

Further, installation of such foregoing hydraulic vehicular ramp systems is somewhat complicated and time intensive in that the ramp hydraulic system typically must be interconnected with the vehicle hydraulic system. Such interconnection often entails the routing of hydraulic lines from the vehicle hydraulic system (e.g., the vehicle brake system) to the ramp. Such interconnecting lines, which are often run within or under the vehicle and are prone to deterioration, wear and leakage, are difficult to access, maintain and repair. The foregoing aspects increase costs to the consumer for maintenance and repair, as well as costs for the initial installation of the ramp system. It would therefore be advantageous to locate substantially all of the hydraulics (e.g., motor, pump, reservoir, lines, cylinders, etc.) within a mounting enclosure to consolidate the hydraulic system so that routing of hoses and lines is simplified, ramp operating noise is reduced and potential fluid leakage is contained and easily repaired. To this end, a self-contained, drop-in type hydraulic wheelchair ramp system including a simplified hydraulic system for reversible actuation would be desirable to the consumer, installer, and repair technician.

Therefore, in view of the foregoing, there exists a need for a simplified and improved hydraulic drive system for wheelchair ramps.

### SUMMARY OF THE INVENTION

One embodiment of the invention provides a hydraulic drive system for reversibly operating a wheelchair ramp, lift or other mobility access device (hereinafter collectively referred to as “ramp”). The hydraulic system could also be used for operating other types of devices that need to be reversibly actuated. The hydraulic drive system includes a bi-directional power unit that is in fluid communication with a cylinder for deploying and stowing the ramp. The system further includes valves disposed between the cylinder and pump, which may be spring biased shuttle-type valves. In one embodiment, the valves are normally biased so that the cylinder and ramp may move freely such that the ramp may be manually operated during a loss of electrical power to the power unit.

### BRIEF DESCRIPTION OF THE DRAWINGS

The present invention is described with reference to the accompanying figures which illustrate embodiments of the present invention. However, it should be noted that the invention as disclosed in the accompanying figures and appendices is illustrated by way of example only.

FIG. 1 illustrates a perspective view of an exemplary wheelchair ramp for which the subject hydraulic system may be employed;

FIG. 2 illustrates a view of the exemplary wheelchair ramp of FIG. 1 with the cover removed to show the internal components including an exemplary hydraulic system;

FIG. 3 is a first hydraulic schematic diagram illustrating one embodiment of the subject hydraulic system;

FIG. 4 is a second hydraulic schematic diagram illustrating another embodiment of the subject hydraulic system; and

FIG. 5 is a partial view of a hydraulic system in accordance with FIG. 4 illustrating a gate valve.

### DETAILED DESCRIPTION OF THE EXEMPLARY EMBODIMENTS

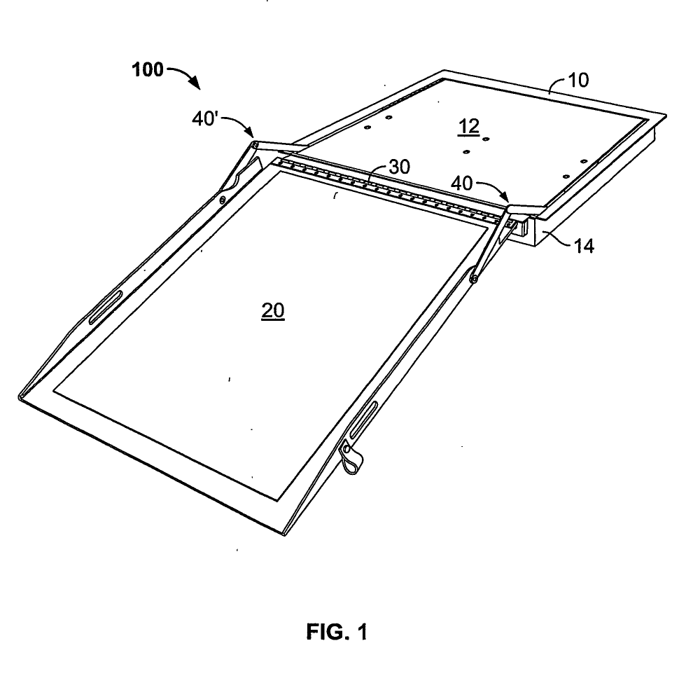

Referring now to the figures, a hydraulic drive system for a device that needs to be reversibly actuated, such as a vehicle wheelchair ramp, is described. As shown in FIG. 1, one exemplary wheelchair ramp (or mobility access device) for which the subject hydraulic drive system may be employed is illustrated as a flip-over type ramp. Although the ramp is illustrated as a flip-over type ramp, the ramp may be other types of ramps such as a bi-fold or multi-fold ramp, a telescoping ramp or other ramps known in the art. Additionally, the subject hydraulic drive system is not limited for use with ramps and may also be used with other types of mobility access devices, such as wheelchair lifts including under-vehicle lifts, stepwell lifts, parallel arm lifts as well as other lifts known in the art. Indeed, the subject hydraulic system may also be used to reversibly drive other types of devices and is not limited to mobility access devices.

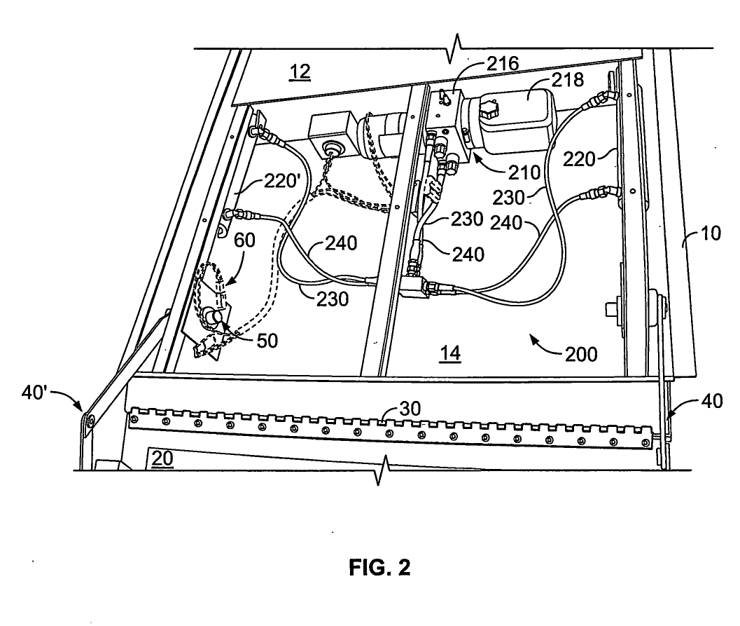

As shown, the ramp 100 includes a mounting enclosure 10 that is typically coupled with the floor of a vehicle threshold so that persons who are physically challenged or otherwise have limited mobility may board and leave a vehicle, such as a minivan, bus, or the like through a proximate sliding or swinging door. The mounting enclosure 10, which is generally rectangular in shape, includes a cover plate 12 and a pan 14 that is recessed into the vehicle floor. As shown in FIG. 2, at least a portion of the cover plate 12 may be removably attached to the pan 14 so that the ramp's components such as mechanical, electrical and hydraulic parts housed within the enclosure 10 and discussed hereafter in further detail may be maintained, repaired, or replaced. In the illustrated embodiments of FIGS. 1-4, the ramp components are fully enclosed within the enclosure 10 so that the wheelchair ramp is substantially self contained and may be installed in suitable vehicles as a “drop-in” system with minimal vehicle modifications. Additionally, as one can appreciate in connection with the exemplary embodiments herein including a hydraulic drive system, potential hydraulic fluid leaks will be contained within the pan 14, hydraulic line routing is minimized and only electrical connections from the vehicle to the ramp system may be required.

For ease of reference, the modifier “inboard” shall refer to a direction toward the vehicle in which the ramp is installed, whereas the modifier “outboard” shall refer to a direction away or outward from the vehicle. As best illustrated in FIG. 1, the ramp 100 includes a movable ramp section 20 that is coupled to the outboard edge of the enclosure 10 by a hinge 30, which may be a piano hinge or the like. The hinge 30 allows the ramp section 20 to move between a stowed orientation in which it is folded substantially flat against the cover plate 12, and a deployed orientation that is achieved by pivoting the ramp section 20 from its stowed orientation through an angle of more than 180 degrees with respect to the plane defining the vehicle threshold surface. As shown, the ramp section 20 may include upwardly projecting side barriers for preventing a ramp user from falling off the right or left sides of the ramp section 20. Further, one or both of the side barriers may include a hand hole, strap or the like that can be gripped by the ramp user or operator to facilitate manual stowage and deployment of the ramp section 20 such as during a malfunction or loss of electrical power to the ramp 100.

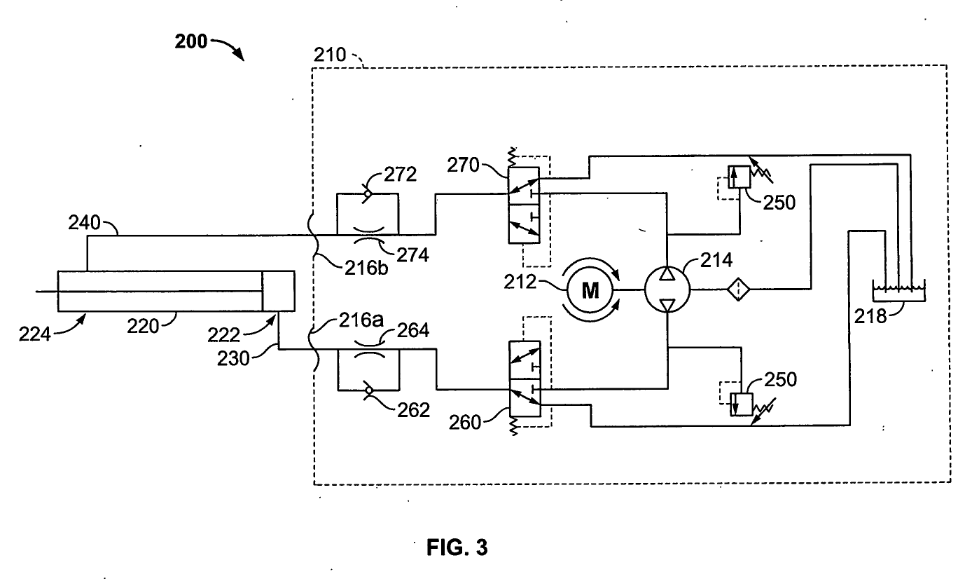

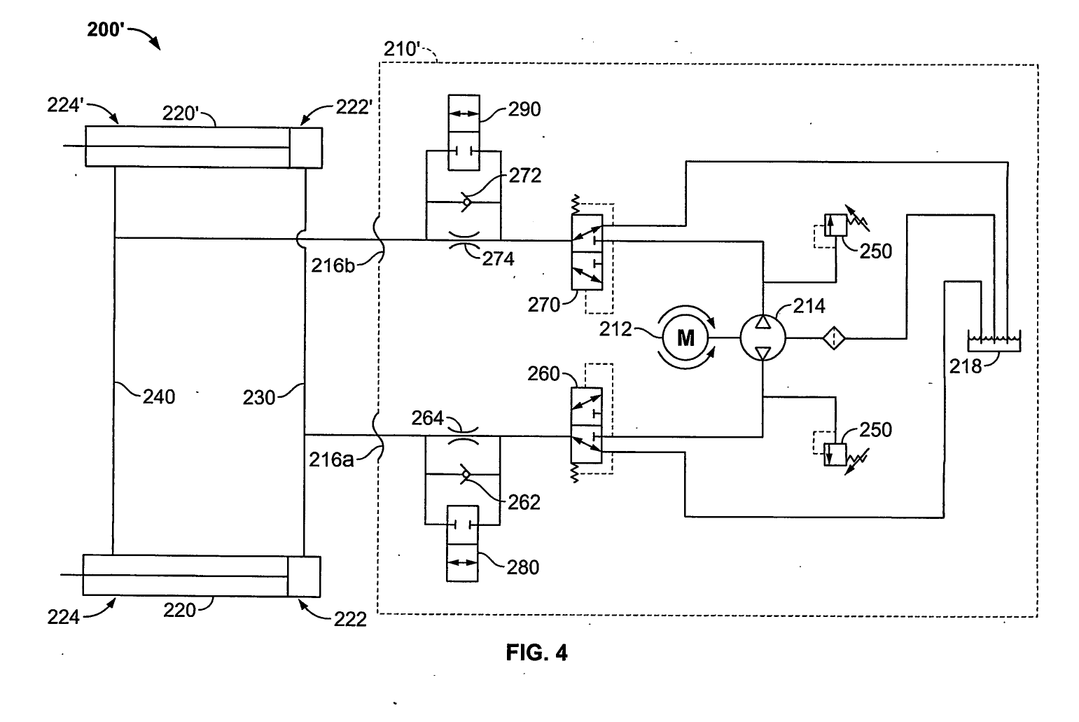

As shown in FIG. 1, the ramp 100 includes linkages 40, 40′ that couple the ramp section 20 to the ramp drive disposed within the enclosure 10 for moving the ramp section 20 between its stowed and deployed orientations. As shown in FIG. 2, the ramp drive includes a hydraulic drive system 200 with a power unit 210 and at least one single-acting cylinder 220 in fluid communication with the power unit 210. Although the drive system 200 of the exemplary ramp 100 illustrated in FIG. 2 is substantially symmetrical and includes two cylinders, the drive system 200 may include one cylinder (FIG. 3), two cylinders (as shown in FIGS. 2 and 4) or more than two cylinders. As is known in the art and best illustrated in FIGS. 2-4, the power unit 210 includes a motor 212, pump 214, a valve manifold 216 and a reservoir 218. As shown in FIGS. 3 and 4, the valve manifold 216 includes two interchangeable inlet/outlet ports 216a, 216b to which hydraulic lines 230, 240 are connected for directing hydraulic fluid between the power unit 210 and the cylinder 220.

Referring now to FIG. 3, the power unit 210 is shown to be a bi-directional power unit with a bi-directional or reversible motor and a bi-directional displacement pump. As such, ports 216a and 216b are each combination inlet/outlet ports that are independent of each other. Exemplary bi-directional power units of this type include model number 108BES19-Z56-1V-25-00-Y sold by the Oildyne Division of the Parker-Hannifin Corporation and part number BIROT-HS available from Monarch Hydraulics, Inc. of Grand Rapids, Mich., but other suitable bi-directional pumps may be substituted as appropriate. As is known in the art, the cylinder 220 includes a movable rod and piston combination and two ports. A first cylinder port is associated with the piston end 222 of cylinder 220 to direct hydraulic fluid to act on the piston to move the rod outward from the cylinder 220, whereas the second cylinder port is associated with the rod end 224 of cylinder 220 to direct hydraulic fluid to move the rod inward. To this end, as shown, line 230 couples the power unit 210 to the piston end 222 and line 240 couples the power unit 210 to the rod end 224.

Associated with each of the ports 216a, 216b is a pressure relief valve 250 for depressurizing the ports 216a, 216b in case of unacceptable hydraulic pressure build up such as when a system component becomes blocked or frozen (e.g., the hydraulic cylinder 220 or the ramp section 20). In addition, since there is less surface area at the rod end 224 for the hydraulic fluid to act on, a greater pressure may be required to stow the ramp section 20 than to deploy it. Thus, each pressure relief valve 250 may be adjusted independently to regulate the pressure at either end 222, 224 of the cylinder 220. Moreover, the pressure relief valves 250 may provide a safety feature by preventing the ramp section 20 from deploying or stowing if an object or obstruction is present on the ramp section 20. For example, if ramp stowage is actuated accidentally while a user is on the ramp section 20, hydraulic pressure will build up between the power unit 210 and the rod end 224 of the cylinder 220 in excess of a predetermined typical pressure required to stow the ramp section 20. To this end, the pressure relief valve 250 associated with the rod end 224 may be set to route fluid to the reservoir 218 when a pressure in excess of the typical predetermined pressure required for ramp stowage is reached, thereby preventing the ramp section 20 from operating until the user completes their traversal of the ramp.

As further shown in FIG. 3, a shuttle valve 260 is inline with the parallel combination of a check valve 262 and flow restrictor 264 between pump 214 and the piston end 222. Similarly, a shuttle valve 270 is inline with the parallel combination of a check valve 272 and flow restrictor 274 between pump 214 and the rod end 224. As shown, the shuttle valves 260, 270 are three way, two position, spring-type valves that are biased to direct hydraulic fluid from the cylinder 220 to the reservoir 218 such that the rod and piston ends 224, 222 are interconnected by a “hydraulic loop” through the reservoir 218. This hydraulic loop configuration allows the ramp section 20 to be manually operated in a “float” mode when needed such as in a “gravity-down” mode or during loss of electrical power to the power unit 210. Furthermore, flow restrictors 264, 274 may be adjustable needle valves or the like and operate to limit the hydraulic fluid return flow thereby slowing or throttling the “gravity-down” operation of the ramp section 20.

With reference to FIG. 3, when ramp deployment is desired, the motor 212 of the bi-directional power unit 210 is activated to actuate the pump 214 to pressurize the hydraulic fluid in a clockwise manner with respect to FIG. 3. The pump 214 draws hydraulic fluid from the reservoir 218 and forces the high pressure fluid through shuttle valve 260 thereby displacing the shuttle of valve 260 to seal off the normally biased reservoir path and build up the pressure in line 230. The increasing hydraulic pressure in line 230 acts on the piston end 222 to move the piston and rod outward thereby moving a link 40 to pivot the ramp section 20 upward and outward. Fluid in the rod end 224 of the cylinder 220 is consequently dumped into the reservoir 218 through line 240 and shuttle valve 270, which is normally biased to direct return fluid to the reservoir 218.

Conversely, when ramp stowage is desired, the motor 212 of the bi-directional power unit 210 is activated to actuate the pump 214 to pressurize the hydraulic fluid in a counter-clockwise manner with respect to FIG. 3. The pump 214 draws hydraulic fluid from the reservoir 218 and forces the high pressure fluid through shuttle valve 270 thereby displacing the shuttle of valve 270 to seal off the normally biased reservoir path and build up the pressure in line 240. The increasing hydraulic pressure in line 240 acts on the rod end 224 to move the rod and piston inward thereby moving a link 40 to pivot the ramp section 20 upward and inward. Fluid in the piston end 222 of the cylinder 220 is consequently dumped into the reservoir 218 through line 220 and shuttle valve 260, which is normally biased to direct return fluid to the reservoir 218.

As previously mentioned, the hydraulic system 200 may enable the ramp section 20 to deploy and stow under gravity power (known as “gravity down”) after the ramp section 20 passes a generally vertical orientation. To provide for gravity down deployment and stowage of the ramp, the ramp 100 may include a sensing means having one or more switches, sensors or the like for detecting the orientation of the ramp section 20. As illustrated in FIG. 2, a cam arrangement 50 may be located on an end of a shaft that moves the linkage 40. As further shown in FIG. 2, an arrangement of sensors or switches 60 (illustrated in broken lines) such as contact microswitches or the like in cooperation with the cam arrangement 50 may be disposed proximate the cam arrangement 50 and oriented for actuation by the one or more cams of the cam arrangement 50 in response to movement of the linkage 40. For example, a first switch or sensor of the switch arrangement 60 may be operable by a first cam to turn off the power unit 210 when the ramp section 20 is generally vertical during deployment (i.e., the ramp section 20 is moving generally outboardly), whereas a second switch or sensor of the switch arrangement 60 may be operable by a second cam to turn off the power unit 210 when the ramp section 20 is generally vertical during stowage (i.e., the ramp section 20 is moving generally inboardly), or vice versa. Such first and second cams may operate to actuate the first and second switches, or second and first switches, respectively.

The sensors or switches of the switch arrangement 60 may be “hard wired” to the power unit 210 or alternatively to a controller, which may be a programmable logic controller, microprocessor controller, or the like. Thus, the power unit 210 may be shut off when respective sensors are actuated during deployment and stowage so the ramp section 20 may gravity-down relative to the return flow throttling restrictors 262, 272. In this way, the ramp 100 selectively operates the power unit 210 relative to the orientation of the ramp section 20 so that the ramp section 20 may be deployed and/or stowed by the force of gravity through an approximate angle of ninety degrees (i.e., from a generally vertical orientation to either the fully stowed or deployed orientation). When the ramp section 20 is moving under the force of gravity, the primary mode of operation of the hydraulic system is suction from the reservoir 218 and return to the reservoir 218.

Referring now to FIG. 4, another exemplary embodiment of the hydraulic system 200′ is described. As shown, the system 200′ is somewhat similar to system 200 of FIG. 3 and includes a power unit 210′ and two cylinders 220, 220′. As shown in FIG. 2, the cylinders 220, 220′ cooperate to move the ramp section 20 at its right and left sides. Further, the system 200′ may include one or more gate valves, which may be a three-way, closed-center valve assembly. As shown in FIG. 4, the system 200′ includes two gate valves 280, 290 which may be incorporated into the power unit 210′, particularly as part of the manifold 216 (FIG. 2). However, the gate valves 280, 290 may alternatively be separate from the power unit 210′. Further as shown, gate valves 280, 290 are associated with both of the piston and rod ends 222, 224 respectively such that gate valve 280 cooperates with check valve 262 and restrictor 264, whereas gate valve 290 cooperates with check valve 272 and restrictor 274. One exemplary gate valve is part number 10802 available from Monarch Hydraulics, Inc. of Grand Rapids, Mich., but other suitable gate valves known in the art may be substituted as appropriate.

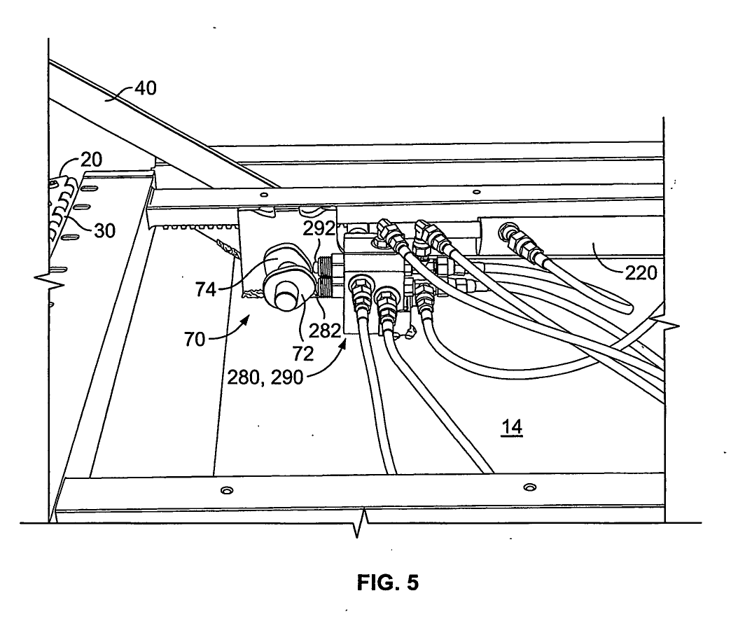

As can be appreciated from FIG. 5, in one exemplary embodiment the gate valves 280, 290 are located remotely from the power unit 210′ and within the pan 14. As shown, each of the gate valves 280, 290 may include a movable member 282, 292 such as an arm, button, lever or the like that may be physically actuated to open and close the respective valves 280, 290. As known in the art, the valves 280, 290 may be manually actuated as illustrated in FIG. 4, but alternatively the valves 280, 290 may be electrically actuated by solenoids or the like. In the illustrated exemplary embodiment of FIG. 5, the ramp 100 includes a second cam arrangement 70. The second cam arrangement 70 is generally similar to the foregoing described cam arrangement 50 for cooperating with the switch arrangement 60 for providing the gravity-down ramp operation, and includes first and second cams 72, 74. As shown in FIG. 5, the movable member 282,292 of gate valves 280,290 are disposed proximate the second cam arrangement 70 that is coupled to a shaft that moves the linkage 40. Further as shown in FIG. 5, cam 72 contacts member 282, whereas cam 74 contacts member 292. However, cams 72, 74 may be disposed otherwise on the shaft to contact members 292, 282, respectively.

As can be appreciated, the cam arrangements 50, 70 may be disposed on the same shaft for ramp embodiments including one cylinder 220 (e.g., FIG. 3), or different shafts for ramp embodiments including more than one cylinder 220, 220′ (e.g., FIG. 4). As illustrated in FIG. 5, each cam 72, 74 of the cam arrangement 70 is rotated on the shaft relative to the orientation of the ramp section 20 (i.e., pivoting or rotational movement of the link 40). As can be appreciated from FIG. 4 and as described hereafter, gate valve 280 opens during an “active” stage of ramp stowage and gate valve 290 opens during an “active” stage of ramp deployment. The term “active” used herein refers to a kinetic motive force being applied to the ramp section 20. Such a kinetic motive force may comprise the flow of pressurized hydraulic fluid as discussed herein or alternatively a motive force that is externally applied to the ramp section 20 by an individual. For example, a person may need to physically handle the ramp section 20 in what is known in the art as a “manual” mode such as if the power unit 210 were to malfunction or the like. To this end, one can appreciate that the gate valves 280, 290 open and close to help with fluid displacement by opening a less restrictive path. More particularly, gate valves 280, 290 facilitate the “active” stages of ramp operation by directing return fluid flow through a less restrictive path in comparison to the restrictors 264, 274. In this way, the gate valves 280, 290 make it easier for an individual to manually deploy and stow the ramp, and the gate valves 280, 290 decrease the burden (i.e., work performed) on the power unit 210 when the power unit 210 is actuated during the powered stages of “active” ramp deployment and stowage (i.e., approximately the first ninety degrees of movement until the ramp section 20 becomes generally vertical with respect to the threshold plane) to facilitate more efficient powered operation of the ramp 100.

With reference now to FIG. 4 operation of the ramp 100 will be described. When ramp deployment is desired from a stowed orientation, the motor 212 of the bi-directional power unit 210′ is activated during an initial deployment stage wherein the ramp section 20 moves from a fully stowed orientation to a generally vertical orientation. The motor 212 actuates the pump 214 to pressurize the hydraulic fluid at port 216a. The pump 214 draws hydraulic fluid from the reservoir 218 and forces the high pressure fluid through shuttle valve 260 thereby displacing the shuttle of valve 260 to seal off the normally biased reservoir path. With reference to FIG. 5, when ramp section 20 is fully stowed, the cam arrangement 70 is rotated such that the cam surface of first cam 72 is rotated away from member 282 and the cam surface of second cam 74 contacts member 292. When the ramp section 20 starts to move from its fully stowed orientation, the cams 72, 74 will rotate in a counter-clockwise manner with the link 40. The second cam 74 will continue to actuate member 292 during deployment so that gate valve 290 remains open to direct return fluid from the cylinders' rod ends 224, 224′ through a less restrictive path than restrictor 274 until the ramp section 20 becomes generally vertical. The gate valve 280 is closed and the high pressure hydraulic fluid flows from the shuttle valve 260, through the check valve 262 and out port 216a to build up the pressure in line 230. The increasing hydraulic pressure in line 230 acts on the piston ends 222, 222′ to move the links 40, 40′ (FIG. 1) to pivot the ramp section 20 upward and outward until the ramp section 20 passes a generally vertical orientation where the power unit 210′ is deactivated. Gate valve 290 is actuated to remain open so long as the power unit 210 is activated so that fluid in the rod ends 224, 224′ of the cylinders 220, 220′ bypasses the restrictor 274 and is dumped into the reservoir 218 by shuttle valve 270, which is normally biased to direct the return fluid to the reservoir 218.

During a second deployment stage subsequent to the foregoing, the ramp section 20 moves from a generally vertical orientation to a fully deployed orientation under gravity power (i.e., gravity-down operation). The power unit 210′ is deactivated and the gate valve 290 closes, whereas the gate valve 280 is opened. The downward gravity movement of the ramp section 20 moves the pistons and rods of cylinders 220, 220′ outward thereby creating a suction path from the reservoir 218 through shuttle valve 260 and gate valve 280 to the piston ends 222, 222′. Since the gate valve 290 is closed the return flow from the rod ends 224, 224′ passes through the restrictor 274 to throttle the downward movement of the ramp section 20. The return flow is dumped into the reservoir 218 by shuttle valve 270, which is normally biased to direct the return fluid to the reservoir 218.

During a first stowage stage when the ramp section 20 moves from a fully deployed orientation to a generally vertical orientation, the motor 212 of the bi-directional power unit 210′ is activated to actuate the pump 214 to pressurize the hydraulic fluid at port 216b. The pump 214 draws hydraulic fluid from the reservoir 218 and forces the high pressure fluid through shuttle valve 270 thereby displacing the shuttle of valve 270 to seal off the normally biased reservoir path. As shown in FIG. 5, the link 40 is oriented such that the ramp section 20 is fully deployed and the cam arrangement 70 is rotated such that the cam surface of first cam 72 contacts member 282 and the cam surface of second cam 74 is rotated away from member 292. When the ramp section 20 starts to stow from its fully deployed orientation, the cams 72, 74 will rotate in a clockwise manner with the link 40. First cam 72 will continue to actuate member 282 during stowage so that gate valve 280 remains open to direct return fluid from the cylinders' piston ends 222, 222′ until the ramp section 20 becomes generally vertical. The gate valve 290 is closed and the hydraulic fluid flows from the shuttle valve 270, through the check valve 272 and out port 216b to build up the pressure in line 240. The increasing hydraulic pressure in line 240 acts on the rod ends 224, 224′ to move the links 40, 40′ (FIG. 1) to pivot the ramp section 20 upward and inward until the ramp section 20 passes a generally vertical orientation where the power unit 210′ is deactivated. Gate valve 280 is actuated to remain open so long as the power unit 210′ is activated so that return fluid from the piston ends 222, 222′ of the cylinders 220, 220′ bypasses the restrictor 264 and is dumped into the reservoir 218 by shuttle valve 260, which is normally biased to direct the return fluid to the reservoir 218.

During a second stowage stage subsequent to the foregoing, the ramp section 20 moves from a generally vertical orientation to a fully stowed orientation under gravity power (i.e., gravity-down operation). The power unit 210′ is deactivated and the gate valve 290 is actuated to be open, whereas the gate valve 280 is closed. The downward gravity movement of the ramp section 20 moves the pistons and rods of cylinders 220, 220′ inward thereby creating a suction path from the reservoir 218 through shuttle valve 270 and gate valve 290 to the rod ends 224, 224′. Since the gate valve 280 is closed, the return flow from the piston ends 222, 222′ passes through the restrictor 264 to throttle the downward movement of the ramp section 20. The return flow is dumped into the reservoir 218 by shuttle valve 260, which is normally biased to direct the return fluid to the reservoir 218.

Exemplary embodiments of this invention are described herein. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A hydraulic system for a device, the system comprising:
a pump including first and second inlet/outlet ports, the pump operative to move the device between a first position and a second position; and
a hydraulic cylinder in fluid communication with the pump and including a rod end coupled with one of the first and second ports and a piston end coupled with the other one of the first and second ports.

2. The system of claim 1 wherein the device comprises a ramp.

3. The system of claim 1 wherein the first position comprises a stowed orientation and the second position comprises a deployed orientation.

4. The system of claim 2 wherein the ramp comprises a wheelchair ramp.

5. The system of claim 1 wherein the pump comprises a bi-directional displacement pump.

6. The system of claim 1 further comprising:
a reservoir in fluid communication with the pump;
a first valve coupling the pump with the rod end and in fluid communication with the reservoir; and
a second valve coupling the pump with the piston end and in fluid communication with the reservoir.

7. The system of claim 6 wherein the first and second valves comprise three-way valves.

8. The system of claim 7 wherein the first and second three-way valves are normally biased in a position to provide a hydraulic loop between the cylinder and the reservoir, the loop independent from the pump.

9. The system of claim 8 wherein the first and second three-way valves comprise a spring configured to bias the valves.

10. The system of claim 7 wherein the first and second three-way valves comprise spring-biased shuttle valves.

11. The system of claim 7 wherein at least one of the first and second three-way valves comprises an electrically-actuated valve.

12. The system of claim 11 wherein the electrically-actuated valve comprises a solenoid valve.

13. The system of claim 7 wherein the first and second three-way valves comprise electrically-actuated valves.

14. The system of claim 13 wherein the electrically-actuated valves comprise solenoid valves.

15. The system of claim 2 further comprising a safety mechanism configured to prevent one or more of a stowing and deployment operation of the ramp.

16. The system of claim 15 wherein the safety mechanism comprises one or more of a first relief valve inline between the pump and the rod end and a second relief valve inline between the pump and the piston end, the first and second relief valves independently adjustable to regulate a pressure at the respective ends.

17. The system of claim 6 further comprising:
a first restriction mechanism coupling the rod end with the reservoir for throttling a hydraulic fluid return flow during a first gravity-movement stage of device operation; and
a second restriction mechanism coupling the piston end with the reservoir for throttling a hydraulic fluid return flow during a second gravity-movement stage of operation.

18. The system of claim 17 wherein the first and second restriction mechanisms comprise restriction orifices.

19. The system of claim 18 wherein the restriction orifices are disposed within a manifold in fluid communication with the pump.

20. The system of claim 17 wherein the first restriction mechanism is disposed between the rod end and the first three-way valve and the second restriction mechanism is disposed between the piston end and the second three-way valve.

21. The system of claim 1 further comprising a second hydraulic cylinder in fluid communication with the pump and configured to cooperate with the first hydraulic cylinder.

22. The system of claim 2 wherein the pump is operative relative to the orientation of the ramp such that the pump moves the ramp from a stowed orientation to a generally vertical orientation and from a deployed orientation to a generally vertical orientation.

23. The system of claim 22 further comprising a sensor in communication with the pump for selectively actuating and deactuating the pump relative to the orientation of the ramp.

24. The system of claim 23 wherein the sensor comprises a cam and switch arrangement.

25. The system of claim 22 further comprising a gate valve disposed between the pump and the cylinder, the gate valve operative relative to the orientation of the ramp for facilitating ramp movement in an active stage of operation.

26. The system of claim 25 wherein the gate valve is manually operated.

27. The system of claim 25 wherein the gate valve is electrically operated.

28. The system of claim 17 further comprising:
a first gate valve in parallel with the first restriction mechanism, the first gate valve operative to bypass the first restriction mechanism during a stage of active deployment; and
a second gate valve in parallel with the second restriction mechanism, the second gate valve operative to bypass the second restriction mechanism during a stage of active stowage.
